(19) United States
(12) Patent Application Publication
(10) Pub. No.: US 2017/0195543 A1
(43) Pub. Date: Jul. 6, 2017

(54) REMOTE CONTROL BETWEEN MOBILE COMMUNICATION DEVICES FOR CAPTURING IMAGES

(71) Applicants: MING-JEN CHEN, ZHUBEI CITY (TW); CHUN-LIN LIN, HSINCHU CITY (TW)

(72) Inventors: MING-JEN CHEN, ZHUBEI CITY (TW); CHUN-LIN LIN, HSINCHU CITY (TW)

(73) Assignee: SkyTraq Technology, Inc., Hsinchu City (TW)

(21) Appl. No.: 15/397,713

(22) Filed: Jan. 3, 2017

Related U.S. Application Data
(60) Provisional application No. 62/274,090, filed on Dec. 31, 2015.

(51) Int. Cl. H04N 5/232; H04N 5/247

(52) U.S. Cl. CPC H04N 5/23203; H04N 5/247; H04N 5/23293; H04N 5/23296; H04N 5/23216

(57) ABSTRACT

An image capturing system may include a first image capturing apparatus, a second image capturing apparatus and a securing apparatus. When in use, the user can rotate the first image capturing apparatus and/or uses its APP interface to adjust the shooting angle. Meanwhile, the second image capturing apparatus is configured to control the securing apparatus to rotate based on the adjustment made on the first image capturing apparatus, until the desired image sent by the second image capturing apparatus is shown on the screen of the first image capturing apparatus. The user then presses the shutter in the APP of the first image capturing apparatus and the command is sent to the second image capturing apparatus to actually take the picture or video and pass it back to the first image capturing apparatus for the user to review.

### CROSS-REFERENCE TO RELATED APPLICATIONS

This application claims priority under 35 U.S.C. §119 (e) to U.S. Provisional Patent Application Ser. No. 62/274,090, filed on Dec. 31, 2015, the entire contents of which are hereby incorporated by reference.

### FIELD OF THE INVENTION

The present invention relates to a method and system for one device to remotely control another device for an image taking/video shooting action, and more particularly to two image capturing devices that “mirror” the actions of each other via a wireless communication link to capture images or video.

### BACKGROUND OF THE INVENTION

Mobile computing devices allow a user to perform a variety of functions, including various forms of communication and computing. For example, some mobile computing devices are capable of accessing the Internet, executing gaming applications, playing videos and music, as well as providing functionality of a traditional cellular telephone. In some examples, users may use multiple computing devices to access and manage information. Such computing devices may communicate with one another using short range wireless communication to share information.

With rapid technological advances in electronics, almost all of the mobile computing devices, in particular of wireless devices like mobile phones, tablets and personal digital assistants (PDA), are equipped with cameras. Meanwhile, the capabilities of these cameras are also becoming better at such a pace that their image quality has often become almost indistinguishable from that of dedicated digital cameras in terms of resolution, color depth and light sensitivity.

Modern digital cameras, including the digital cameras built in the mobile phones, have the function of delayed timing picture taking. With this function, a photographer can prepare the background scene, set up the timer for 10, 15, or 20 seconds delay, place himself/herself or any other subject in the scene, and allow the timer to capture a picture or a shot of a scene automatically upon the expiration of the timer. However, this function requires the photographer to prepare the scene and setup the camera carefully beforehand. Once the timer is started, photographer cannot control the camera again for its parameter adjustment, for example, the focal length, the flash usage, and the like. To enable a photographer to more fully and easily control a camera, various dedicated camera remote controllers have been developed. With such a dedicated remote control, a photographer can activate the camera from a distance, place himself in the scene, and control the camera to take photographs. However, these remote control units themselves are dedicated instruments that serve no purpose other than to act a dedicated remote controller for a camera.

Therefore, there remains a need for a new and improved system to overcome the problems stated above by using two camera devices that “mirror” the actions of each other via a wireless communication link to take pictures or shoot videos.

### SUMMARY OF THE INVENTION

In one aspect, an image capturing system may include a first image capturing apparatus, a second image capturing apparatus and a securing apparatus. In one embodiment, the first image capturing apparatus can be a smart phone with an APP (“Application Software”) designed to provide an interface to control the picture taking or video shooting, e.g. shutter release and zooming, so the hardware of the smart phone does not need to be changed for this invention. In another embodiment, the first image capturing apparatus may have a GNSS/GPS sensor to detect its own location and inertial sensors to detect its own movement. Likewise, these sensors are actually available in current smart phones. In a further embodiment, the first image capturing apparatus may have a wireless communication link, e.g. Wi-Fi and/or Bluetooth, to transfer pictures and commands to the second image capturing apparatus. In still a further embodiment, the first image capturing apparatus can also communicate with the securing apparatus and control the rotation movements (pitch/roll/yaw) thereof.

The second image capturing apparatus can also be a smart phone with a communication link, e.g. Wi-Fi and/or Bluetooth, to communicate with the first image capturing apparatus, and the securing apparatus to control the rotation movement (pitch/roll/yaw) thereof. In one embodiment, the second image capturing apparatus may have a GNSS/GPS sensor to detect its own location and an image sensor as in current smart phones. In another embodiment, the second image capturing apparatus may have a radar sensor. In a further embodiment, the second image capturing apparatus may have a wireless communication link, e.g. Wi-Fi and/or Bluetooth, to transfer pictures and commands to the first image capturing apparatus.

The securing apparatus can be physically mounted to the second image capturing apparatus. In one embodiment, the securing apparatus has a communication link, e.g. Wi-Fi and/or Bluetooth, to wirelessly communicate with the first image capturing apparatus and the second image capturing apparatus. It is noted that the securing apparatus follows the instructions given or passed by the first image capturing apparatus and/or the second image capturing apparatus to make rotation movements (pitch/roll/yaw). It is also noted that the securing apparatus may be movable, for example, the securing apparatus along with the second image capturing apparatus may be disposed on a mobile object, such as a robot.

When in use, the user can rotate the first image capturing apparatus and/or uses its APP interface to adjust the image shooting angle (pitch/roll/yaw). Meanwhile, the second image capturing apparatus is configured to control the securing apparatus to rotate based on the adjustment of the first image capturing apparatus, until the desired image sent by the second image capturing apparatus is shown on the screen of the first image capturing apparatus. The user then presses the shutter in the APP of the first image capturing apparatus, or moves the first image capturing apparatus in a particular way, e.g. shaking, meaning the user is not satisfied with the image sent from the second image capturing apparatus, and the command is sent back to the second image capturing apparatus to retake the picture and pass it back to the first image capturing apparatus for the user to review again. In another embodiment, the user can change the orientation (portrait/landscape) of the first image capturing apparatus to control the second image capturing apparatus, driven by the securing apparatus. In a further embodiment, the first image capturing apparatus can be used to control zoom in/zoom out operations of the second image capturing apparatus. It is noted that the image capturing system in the present invention can not only be used to capture images, but also videos, which is a series of continuous image frames.

In summary, the user would feel like taking a picture or shooting a video of him/herself in front of a mirror with the image capturing system in the present invention. He/she can use the first image capturing apparatus to take a picture or shoot a video, but the picture/video is actually taken/shot by the second image capturing apparatus. The user can see the image in the second image capturing apparatus at the first image capturing apparatus before finalizing the image taking or video shooting action. Once the image is taken by the second image capturing apparatus, the same image is at display and transmitted to and stored at the first image capturing apparatus. Furthermore, the user who holds the first image capturing apparatus can rotate (pitch/roll/yaw) it to adjust the shooting angle, and the second image capturing apparatus can follow the motion of the first image capturing apparatus via the rotation movement of the securing apparatus. It is important to note that in addition to the APP on the first image capturing apparatus, the motion sensor on the first image capturing apparatus can be used to detect the gesture movement of the first image capturing apparatus and further operate the second image capturing apparatus for (i) shooting orientation (portrait/landscape); (ii) zooming; (iii) simulating axial rotation (pitch/roll/yaw); and (iv) pressing the shutter to take pictures or shoot videos. Moreover, when the user is moving, the GPS/GNSS, IMU, image and/or sonar sensors on one image capturing apparatus can be used to track the movement of the user with the other image capturing apparatus by axial rotation (pitch/roll/yaw).

### BRIEF DESCRIPTION OF THE DRAWINGS

FIG. 1 is a schematic view of the image capturing system in the present invention.

FIG. 2 is a schematic view of the communication between the devices in the image capturing system in the present invention.

FIG. 3 illustrates one embodiment showing how the first image capturing apparatus controls the movement of the second image capturing apparatus.

FIG. 4 illustrates another embodiment showing how the first image capturing apparatus controls the movement of the second image capturing apparatus.

FIG. 5 illustrates a further embodiment showing how the first image capturing apparatus controls the movement of the second image capturing apparatus.

FIG. 6 illustrates a schematic view of how the two image capturing apparatus that “mirror” the actions of each other via a wireless communication link to take picture or shoot video in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In order to further understand the goal, characteristics and effect of the present invention, a number of embodiments along with the drawings are illustrated as following:

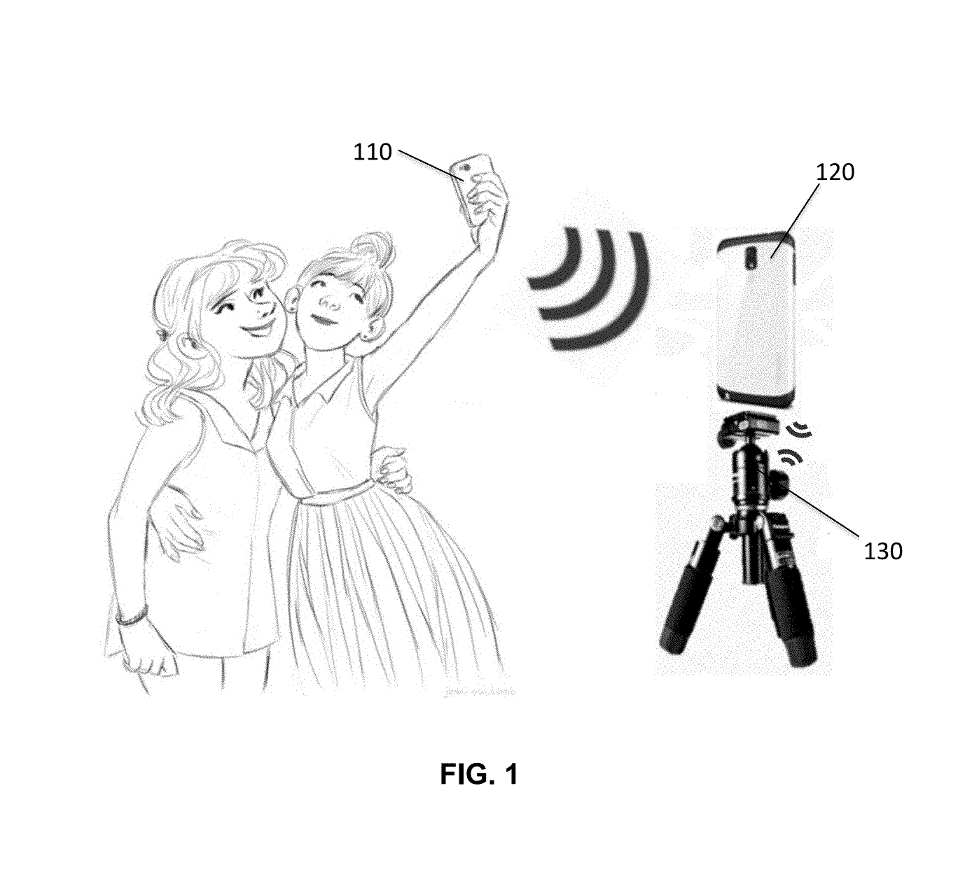

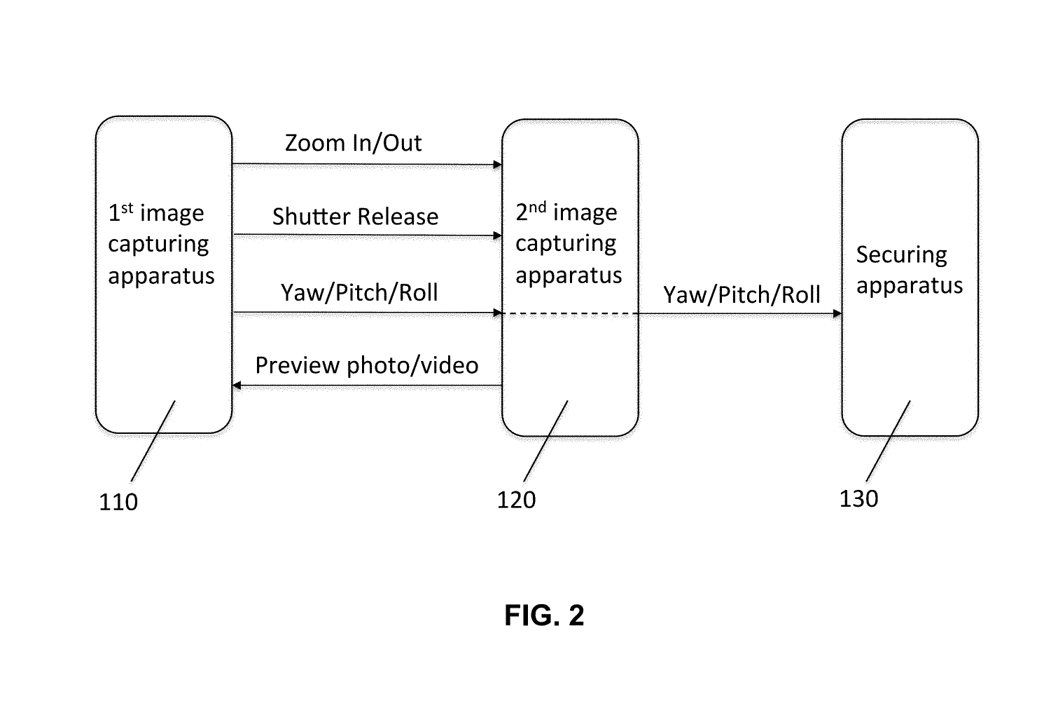

In one aspect, referring to FIGS. 1 to 2, an image capturing system may include a first image capturing apparatus 110, a second image capturing apparatus 120 and a securing apparatus 130. In one embodiment, the first image capturing apparatus 110 can be a smart phone with an APP (“Application Software”) designed to provide an interface to control the picture taking or video shooting, e.g. shutter release and zooming, so the hardware of the smart phone does not need to be changed for this invention. In another embodiment, the first image capturing apparatus 110 may have a GNSS/GPS sensor to detect its own location and inertial sensors to detect its own movement. Likewise, these sensors are actually available in current smart phones. In a further embodiment, the first image capturing apparatus 110 may have a wireless communication link, e.g. Wi-Fi and/or Bluetooth, to transfer pictures and commands to the second image capturing apparatus 120. In still a further embodiment, the first image capturing apparatus 110 can also communicate with the securing apparatus 130 and control the rotation movements (pitch/roll/yaw) thereof. It is noted that the first image capturing apparatus 110 may be movable, for example, it may be disposed on a mobile object, such as a robot.

The second image capturing apparatus 120 can also be a smart phone with a communication link, e.g. Wi-Fi and/or Bluetooth, to communicate with the first image capturing apparatus 110, and the securing apparatus 130 to control the rotation movement (pitch/roll/yaw) thereof. In one embodiment, the second image capturing apparatus 120 may have a GNSS/GPS sensor to detect its own location and an image sensor as in current smart phones. In another embodiment, the second image capturing apparatus 120 may have a radar sensor. In a further embodiment, the second image capturing apparatus 120 may have a wireless communication link, e.g. Wi-Fi and/or Bluetooth, to transfer pictures and commands to the first image capturing apparatus 110.

The securing apparatus 130 can be physically mounted to the second image capturing apparatus 120. In one embodiment, the securing apparatus 130 has a communication link, e.g. Wi-Fi and/or Bluetooth, to wirelessly communicate with the first image capturing apparatus 110 and the second image capturing apparatus 120. It is noted that the securing apparatus 130 follows the instructions given or passed by the first image capturing apparatus 110 and/or the second image capturing apparatus 120 to make rotation movements (pitch/roll/yaw). It is also noted that the securing apparatus 130 may be movable, for example, the securing apparatus 130 along with the second image capturing apparatus 120 may be disposed on a mobile object, such as a robot.

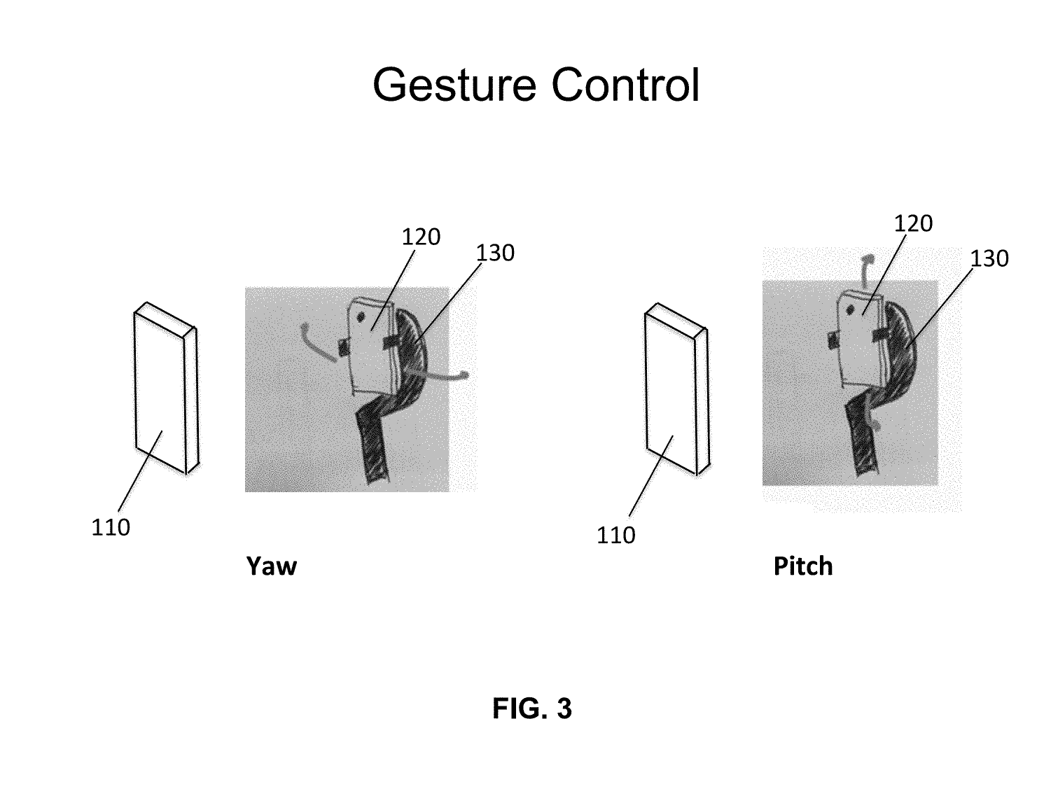

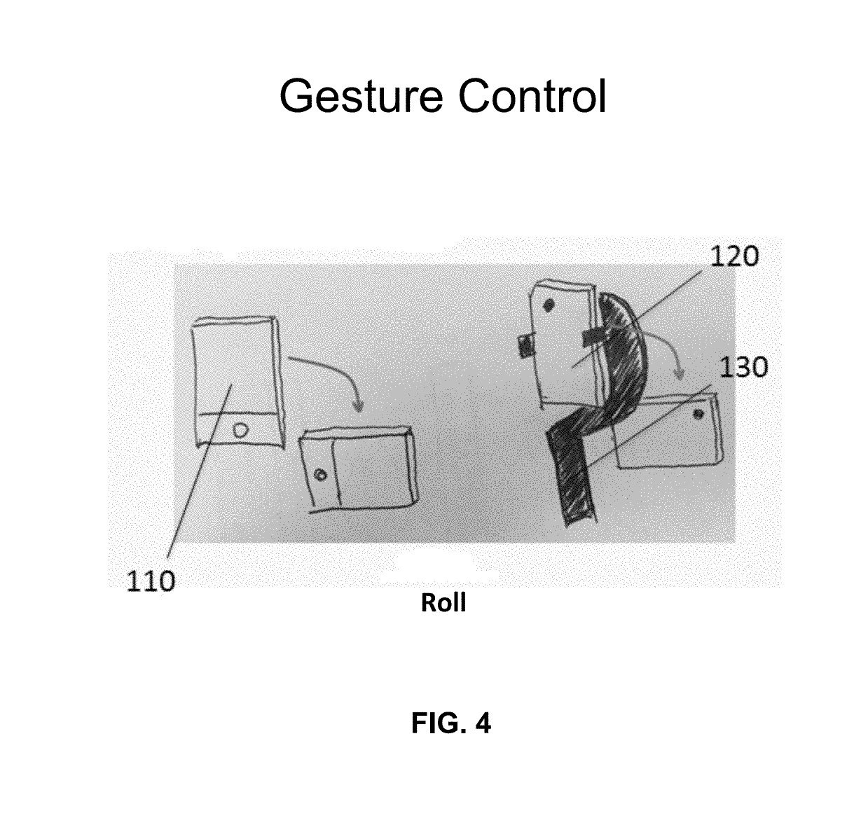

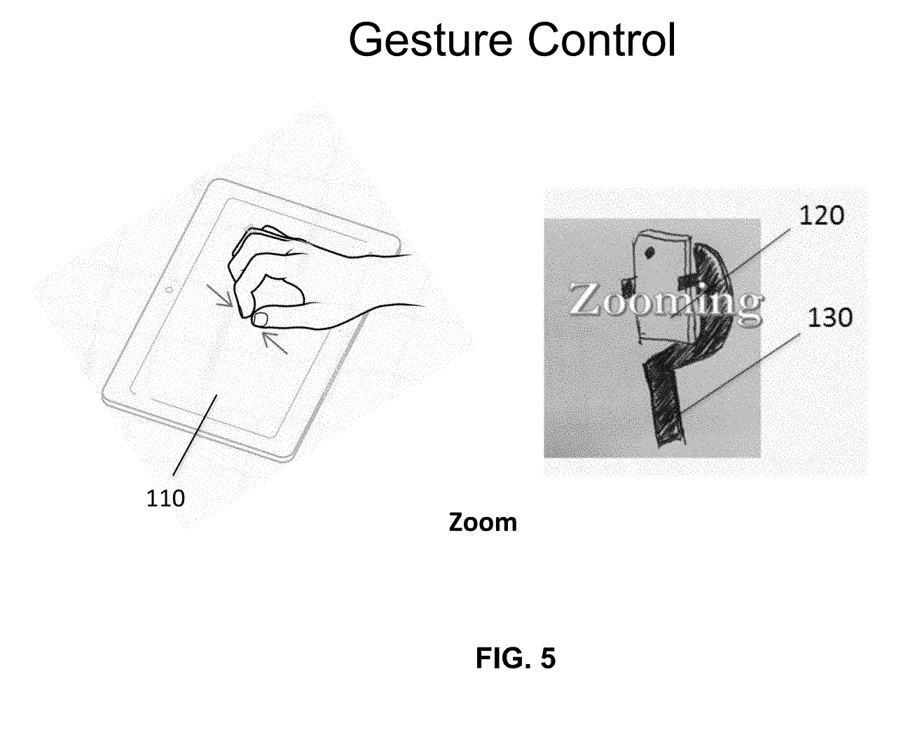

When in use, referring to FIG. 3, the user can rotate the first image capturing apparatus 110 and/or uses its APP interface to adjust the image shooting angle (pitch/roll/yaw). Meanwhile, the second image capturing apparatus 120 is configured to control the securing apparatus 130 to rotate based on the adjustment of the first image capturing apparatus 110, until the desired image sent by the second image capturing apparatus 120 is shown on the screen of the first image capturing apparatus 110. The user then presses the shutter in the APP of the first image capturing apparatus 110, or moves the first image capturing apparatus 110 in a particular way, e.g. shaking, meaning the user is not satisfied with the image sent from the second image capturing apparatus 120, and the command is sent back to the second image capturing apparatus 120 to retake the picture and pass it back to the first image capturing apparatus 110 for the user to review again. In another embodiment, the user can change the orientation (portrait/landscape) of the first image capturing apparatus 110 to control the second image capturing apparatus 120, driven by the securing apparatus 130 as shown in FIG. 4. In a further embodiment, the first image capturing apparatus 110 can be used to control zoom in/zoom out operations of the second image capturing apparatus 120 as shown in FIG. 5.

The image capturing system in the present invention can also be used when the parents try to take pictures or shoot videos of their children. For example, when the parents take the children to the park, the parents can stay slightly further away from the children who are playing, and take pictures or shoot videos of the playing children by controlling the second image capturing apparatus 120 located between the parents and children and finalizing the image taking action on the first image capturing apparatus 110.

A similar use case can be taking pictures or videos of wild animals. Wild animals may be frightened and can be dangerous if people are too close to them, so we can disposed the second image capturing apparatus 120 and the securing apparatus 130 between the user with the first image capturing apparatus 110 and the wild animals, and the user can control the second image capturing apparatus 120 from a predetermined distance away from the wild animals, which would be safe for the user and the animals will not be disturbed.

The position of the user can be automatically tracked by the system in the present invention. More specifically, the GPS/GNSS sensors in the first image capturing apparatus 110 and the second image capturing apparatus 120 can be used to determine a new location of the user if he/she moves, so the securing apparatus 130 can be controlled by the second image capturing apparatus 120 to automatically adjust the shooting angle. Also, the inertial sensors in the first image capturing apparatus 110 can be used to determine the new location of the user according to his/her previous location, and the information can be passed from the first image capturing apparatus 110 to the second image capturing apparatus 120 to control the securing apparatus 130. Furthermore, the image or radar sensor in the second image capturing apparatus 120 can be used to track the movement of the user along with the first image capturing apparatus 110, and the information can also be used for the second image capturing apparatus 120 to control the securing apparatus 130.

The first image capturing apparatus 110 may further comprises a motion sensor to automatically detect the its own movement as held by the user, the information of which can be sent through the communication link to the second image capturing apparatus 120 to control the securing apparatus 130 to adjust the shooting angle (pitch/roll/yaw) of the second image capturing apparatus 120 as shown in FIG. 3. Furthermore, the information detected by the motion sensor can be sent through the communication link to the second image capturing apparatus 120 to control the shutter for shooting orientation (portrait/landscape) as shown in FIG. 4, and zooming as shown in FIG. 5 of the second imaging capturing apparatus 120. It is noted that the image capturing system in the present invention can not only be used to capture images, but also videos, which is a series of continuous image frames.

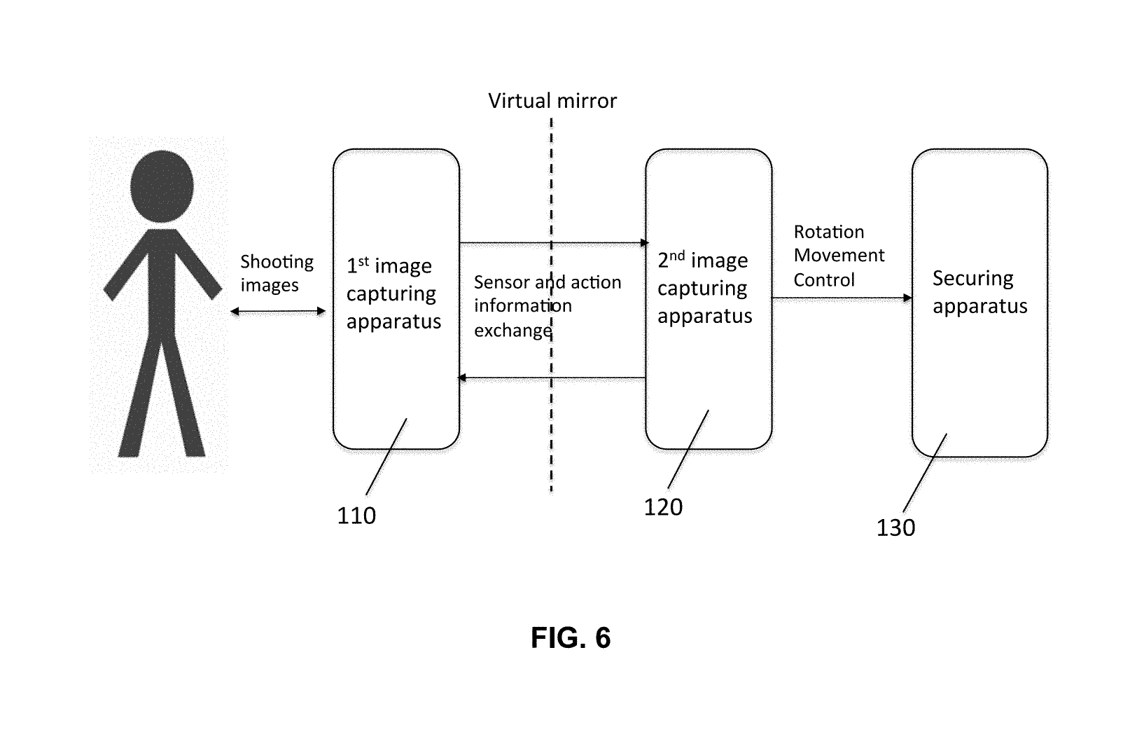

In summary, as shown in FIG. 6, the user would feel like taking a picture or shooting a video of him/herself in front of a mirror with the image capturing system in the present invention. He/she can use the first image capturing apparatus 110 to take a picture or shoot a video, but the picture/video is actually taken/shot by the second image capturing apparatus 120. The user can see the image in the second image capturing apparatus 120 at the first image capturing apparatus 110 before finalizing the image taking or video shooting action. Once the image is taken by the second image capturing apparatus 120, the same image is at display and transmitted to and stored at the first image capturing apparatus 110. Furthermore, the user who holds the first image capturing apparatus 110 can rotate (pitch/roll/yaw) it to adjust the shooting angle, and the second image capturing apparatus 120 can follow the motion of the first image capturing apparatus 110 via the rotation movement of the securing apparatus 130. It is important to note that in addition to the APP on the first image capturing apparatus 110, the motion sensor on the first image capturing apparatus 110 can be used to detect the gesture movement of the first image capturing apparatus 110 and further operate the second image capturing apparatus 120 for (i) shooting orientation (portrait/landscape); (ii) zooming; (iii) simulating axial rotation (pitch/roll/yaw); and (iv) pressing the shutter to take pictures or shoot videos. Moreover, when the user is moving, the GPS/GNSS, IMU, image and/or sonar sensors on one image capturing apparatus can be used to track the movement of the user with the other image capturing apparatus by axial rotation (pitch/roll/yaw).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An image capturing system comprising a first image capturing apparatus;
a second image capturing apparatus; and a securing apparatus, wherein the first image capturing apparatus, the second image capturing apparatus and the securing apparatus are communicatively connected with each other, and the first image capturing apparatus is configured to remotely control the second image capturing apparatus and the securing apparatus, review an image sent from the second image capturing apparatus, and finalize an image capturing action,
wherein the second image capturing apparatus is configured to receive commands from the first image capturing apparatus to manipulate an image and send the image to the first image capturing apparatus for review,
wherein the securing apparatus is physically engaged with the second image capturing apparatus and receives commands from the first image capturing apparatus to make rotation movements of the second image capturing apparatus to capture the image.

2. The image capturing system of claim 1, wherein the first image capturing apparatus is a mobile electronic device with an application software (APP) designed to provide an interface to control the image capturing action, such as shutter releasing and zooming.

3. The image capturing system of claim 1, wherein the first image capturing apparatus includes a GNSS/GPS sensor to detect location thereof and inertial sensors to detect movements thereof.

4. The image capturing system of claim 1, wherein the first image capturing apparatus includes a wireless communication link, such as Wi-Fi and/or Bluetooth, to communicate with the second image capturing apparatus and the securing apparatus.

5. The image capturing system of claim 1, wherein the second image capturing apparatus includes a GNSS/GPS sensor to detect location thereof and inertial sensors to detect movements thereof.

6. The image capturing system of claim 1, wherein the second image capturing apparatus includes a wireless communication link, such as Wi-Fi and/or Bluetooth, to communicate with the first image capturing apparatus and the securing apparatus.

7. The image capturing system of claim 1, wherein the securing apparatus is configured to make rotation movements including pitch, roll and yaw.

8. The image capturing system of claim 7, wherein the securing apparatus can also receive commands from the second image capturing apparatus to make rotation movements including pitch, roll and yaw.

9. The image capturing system of claim 1, wherein the securing apparatus along with the second image capturing apparatus are disposed on a mobile object.

10. The image capturing system of claim 1, wherein the image captured by the image capturing system includes a continuous image frame, namely a video.

11. The image capturing system of claim 9, wherein the image captured by the image capturing system includes a continuous image frame, namely a video.

12. The image capturing system of claim 1, wherein the first image capturing apparatus is disposed on a mobile object.
